(19) United States
(12) Patent Application Publication
(10) Pub. No.: US 2016/0123078 A1
(43) Pub. Date: May 5, 2016

(54) GLASS SLIDING GATE AND GLASS FENCE ASSEMBLY

(71) Applicant: GROUPE VFG, Bois-des-Filion (CA)

(72) Inventor: Serge BOUTHILLIER, Ste-Marthe-sur-le-Lac (CA)

(21) Appl. No.: 14/929,798

(22) Filed: Nov. 2, 2015

Related U.S. Application Data
(60) Provisional application No. 62/073,463, filed on Oct. 31, 2014.
(60) Provisional application No. 62/133,037, filed on Mar. 13, 2015.
(60) Provisional application No. 62/141,573, filed on Apr. 1, 2015.

(51) Int. Cl. E06B 11/02; E06B 3/46; E06B 3/02; E05D 13/00; E05D 15/06

(52) U.S. Cl. CPC E06B 11/026; E05D 13/10; E05D 15/0678; E05D 15/0686; E06B 3/02; E06B 3/4681; E06B 3/4636

(57) ABSTRACT

A support bracket for supporting a glass panel comprises a base adapted to be anchored to a ground or structure. A glass interface is configured to be connected to a glass panel for the support bracket to support a portion of the glass panel. A height adjustment mechanism operatively connects the base to the glass interface, the height adjustment mechanism enabling a translational upward and downward movement of the glass interface relative to the base and being lockable to maintain the glass interface at a desired height. A leveling adjustment mechanism is in the base for adjusting a level of the base relative to the ground or structure, the leveling adjustment mechanism being lockable to maintain the base at a desired leveling.

### CROSS-REFERENCE TO RELATED APPLICATIONS

The present application claims priority on U.S. Provisional Patent Application No. 62/073,463, filed on Oct. 31, 2014; on U.S. Provisional Patent Application No. 62/133,037, filed on Mar. 13, 2015; and on U.S. Provisional Patent Application No. 62/141,573, filed on Apr. 1, 2015, all of which are incorporated herein by reference.

### TECHNICAL FIELD

The present disclosure relates to sliding components made of structural glass panel such as a gates and fences and, more particularly, to hardware used with such glass sliding panels.

### BACKGROUND OF THE ART

Structural glass panels are increasingly used as partitions, due to their transparency and pure look. Gates and fences made of structural glass panels are now also common. However, the glass panels used for such applications are relatively heavy, and appropriate hardware must hence be employed to support the loads associated with structural glass. Moreover, unlike traditional materials such as wood, glass panels may often be treated in plant (e.g., tempered) and are unworkable/unsculptable during installation, which causes difficulties during their installation. Also, the hardware must have a minimalist design so as not to impede the transparency, translucency and pure look of structural glass panel. It is desirable to design hardware that is simplistic while being capable of supporting the weight of such structural glass panels.

In the case of their use as gates and fences, structural glass panels serve a guarding feature. It is therefore desirable that gates and fences using structural glass panels have the same safety features as other types of gates and fences, such as door closers, structural integrity, etc.

### SUMMARY

It is an aim of the present disclosure to provide a glass sliding gate and glass fence assembly that addresses issues associated with the prior art.

Therefore, in accordance with the present disclosure, there is provided a support bracket for supporting a glass panel comprising: a base adapted to be anchored to a ground or structure; a glass interface configured to be connected to a glass panel for the support bracket to support a portion of the glass panel; a height adjustment mechanism operatively connecting the base to the glass interface, the height adjustment mechanism enabling a translational upward and downward movement of the glass interface relative to the base and being lockable to maintain the glass interface at a desired height; and a leveling adjustment mechanism in the base for adjusting a level of the base relative to the ground or structure, the leveling adjustment mechanism being lockable to maintain the base at a desired leveling.

In accordance with another embodiment of the present disclosure, there is provided a glass sliding gate assembly comprising: a glass gate comprising a main glass panel and a horizontal slot in the panel; roller units adapted to be secured to a structure, the roller units each having a rolling wheel received in the horizontal slot to support the glass gate and rotate as the glass gate translates along its plane; a door closer comprising: a biasing mechanism adapted to be secured to the structure, and a door interface secured to the glass gate, the door interface having a carriage operatively connected to the biasing mechanism so as to be subjected to a biasing force to bias the glass gate in a direction.

### DESCRIPTION OF THE DRAWINGS

FIG. 1 is an elevation view of a glass sliding gate and glass fence assembly in accordance with the present disclosure;

FIG. 2 is an enlarged view of a mechanical door closer of the assembly of FIG. 1;

FIG. 3 is an enlarged perspective view of a follower device and rail of the assembly of FIG. 1;

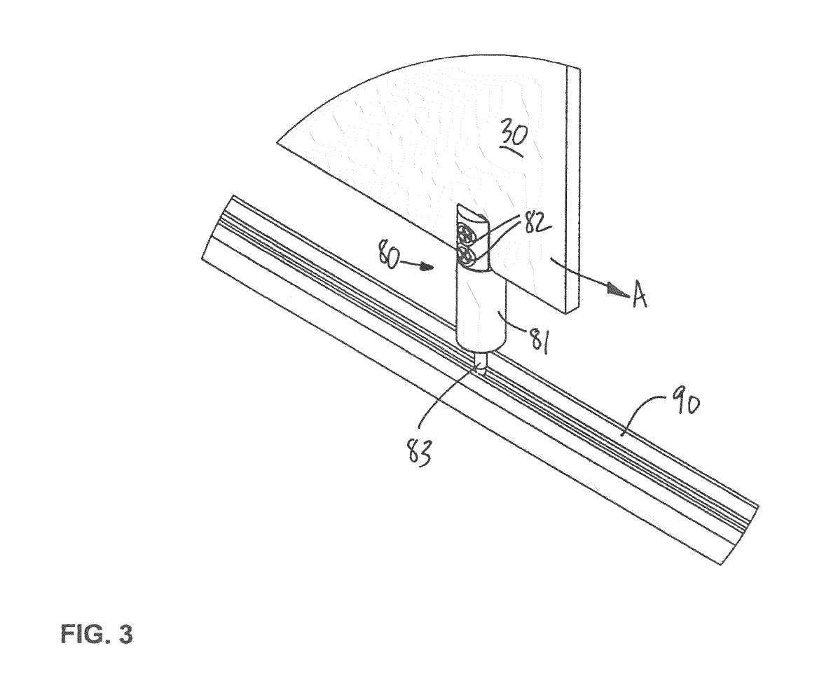

FIG. 4 is an assembly view of a support bracket of the glass sliding gate and glass fence assembly of FIG. 1;

FIG. 5 is an assembled perspective view of the support bracket of FIG. 4;

FIG. 6 is a perspective view of a base of the support bracket of FIG. 4;

FIG. 7 is an assembled perspective view of another embodiment of the support bracket of the glass sliding gate and glass fence assembly of FIG. 1;

FIG. 8 is an assembled perspective view of another embodiment of the support bracket of the glass sliding gate and glass fence assembly of FIG. 1; and

FIG. 9 is an enlarged perspective view of the support bracket of FIG. 8.

### DETAILED DESCRIPTION

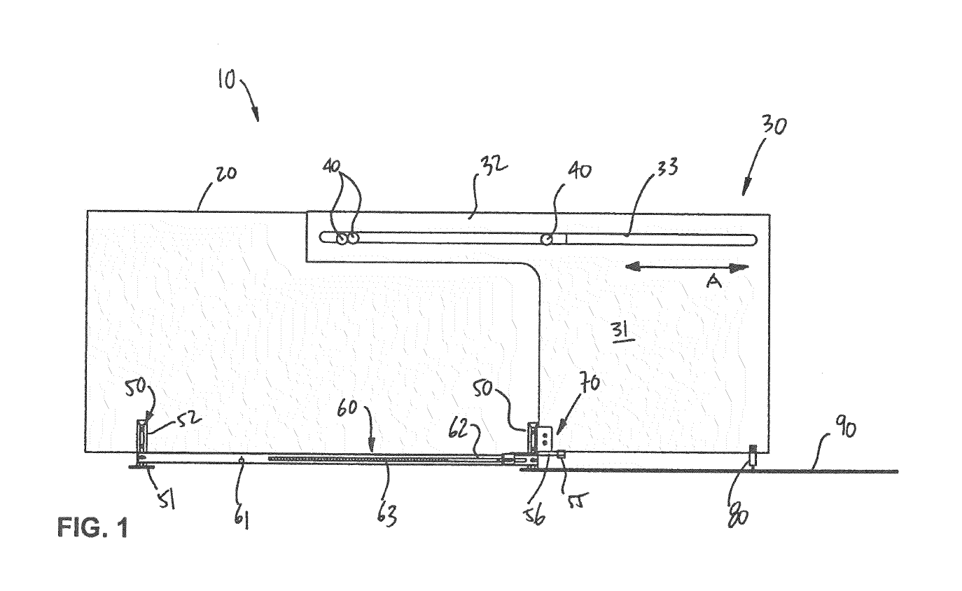

Referring to the drawings and more particularly to FIG. 1, a glass sliding gate and glass fence assembly is generally shown at 10. The assembly 10 comprises a glass fence panel 20 and a glass sliding gate 30. Although a single glass fence panel 20 and glass sliding gate 30 are shown, it is contemplated to use a plurality of the glass fence panels 20 to form a fence, with one or more glass sliding gates 30. For instance, the glass fence panel 20 may be used as a fence surrounding a boundary, even without the glass sliding gate 30. It is for example contemplated to use the assembly 10 around a swimming pool. Likewise, the assembly 10 may be used as a balustrade to delimit a deck or patio among numerous other possible uses. Outdoor and indoor uses are both considered as well for the assembly 10. Hence, the number of glass fence panels 20 and glass sliding gates 30 will be determined as a function of the contemplated use of the assembly 10, and factors such as the perimeter to fence, the number of access openings required, etc.

The glass sliding gate 30 slides in a direction shown as A, relative to the glass fence panel 20. The expressions “sliding” is used as commonly known in the trade, although the movement could appropriately be described as a translation or movement along one translational degree of freedom. In practical terms, the gate 30 moves in its main plane. For this purpose, the assembly 10 features one or more of the following items: roller unit 40, support bracket 50, a door closer constituted of a biasing mechanism 60 and door interface 70, a follower device 80 and a rail 90, although it is contemplated that the assembly 10 may be without some of these components, for example if the assembly 10 does not have any glass sliding gate 30.

The roller units 40, three of which are shown in FIG. 1, are provided to support substantial portion of the glass sliding gate 30, and to allow translational movement of the glass sliding gate 30 in direction A, by their rolling movement. The roller units 40 may be any appropriate type of roller, although it is considered to use roller units as described in U.S. Patent Application Publication No. 2010/0307063, incorporated herein by reference. In particular, the presence of a sheave or like groove in the roller units 40 helps ensuring that the gate 30 remains substantially in its plane when translating.

The support brackets 50, two of which are shown, support the glass fence panel 20 in the upstanding position shown in FIG. 1. Moreover, the support brackets 50 are anchored to the ground or to the floor and hence act as a structural component for the assembly 10. The support brackets 50 have appropriate mechanisms to level the glass fence panels 20, such that a sequence of the panels 20 installed side by side to form a fence are properly aligned relative to one another, in spite of an uneven floor upon which the assembly 10 is mounted.

The door closer is used to automatically close the door. The biasing mechanism 60 biases the glass sliding gate 30 toward the closed position, which closed position is shown in FIG. 1. The biasing mechanism 60 performs a safety feature of the assembly 10. The door interface 70 interfaces the glass sliding gate 30 to the biasing mechanism 60 and hence transmits the biasing forces of the biasing mechanism 60 to the glass sliding gate 30.

The follower device 80 is used in combination with the rail 90 so as to ensure that the glass sliding gate 30 limits its lateral vibrations when moving in direction A.

Still referring to FIG. 1, the glass fence panel 20 and the glass sliding gate 30 are shown in the closed position of the glass sliding gate 30. The glass fence panel 20 and the glass sliding gate 30 are typically made of structural tempered glass of any appropriate thickness to withstand impacts to which are exposed partitions of this nature. The glass fence panel 20 and the glass sliding gate 30 may be transparent, translucent, with or without patterns therein. It is contemplated to use the glass sliding gate 30 with a fence panel 20 that is not made of glass, or vice versa, although in many instances the combination of glass fence panels 20 and glass sliding gates 30 define a homogeneous look.

The glass sliding gate 30 has a main panel 31 of generally square shape (other shapes being contemplated) with a panel extension 32. The panel extension 32 is an elongated portion that projects from a side of the main panel 31 and is planar therewith. In the illustrated embodiment, the main panel 31 and panel extension 32 are a monolithic glass piece. Slot 33 is defined in both the main panel 31 and the panel extension 32. As an alternative to slot 33, it is considered to define a channel between a pair of structural beams that would be connected to the main panel 31, although the configuration shown in FIG. 1 emphasizes the pure look of glass by having the slot 30 machined into the combination of the main panel 31 and the panel extension 32. As yet another embodiment, the gate 30 may be without the panel extension 32 but simply feature instead the slot 33 in the main panel 31. It should be pointed out that the glass sliding gate 30 is made of glass that is of sufficient structural integrity so as to allow the glass sliding gate 30 to be supported by the roller units 40, as at least a substantial portion of the weight of the glass sliding gate 30 will rest on the roller units 40, whereby the panel extension 32 will bear an important part of this load, in a cantilevered arrangement. It is also considered to provide more than one of the horizontal slots 33, to help support the glass sliding gate 30 with roller units 40 in different slots.

Still referring to FIG. 1, the roller units 40 are shown as being located in the slot 33. The roller units 40 are secured to the glass fence panel 20 and project from a plane thereof so as to have their rolling wheels received in the slot 33. Three roller units 40 are shown in FIG. 1, with a pair of the roller units 40 being in close proximity near the free end of the panel extension 32. The pair of roller units 40 at the free end of the panel extension 32 are vertically offset from one another, whereby one of the roller units 40 contacts the top edge of the slot 33 while the other of the roller units 40 contacts a bottom edge of the slot 33. This configuration limits any pivoting movement of the glass sliding gate 30 about an axis that is parallel to the rotational axes of the roller units 40. The roller unit 40 at the right-hand side in FIG. 1 may indeed define an unwanted pivot point for movement of the glass sliding gate 30 about an axis normal to its plane, whereby the pair of roller units 40 on the left-hand side prevent or reduce this pivoting movement. However, a pair of roller units 40 may suffice, with other components of the assembly 10 preventing or limiting the pivoting movement.

The glass fence panel 20 is shown having a pair of the support brackets 50. The support brackets 50 are positioned at opposite ends of the glass fence panel 20 and are of sufficient structural integrity so as to support the glass fence panel 20 and thus indirectly a substantial portion of the weight of the glass sliding gate 30 via the roller units 40. Although a pair of support brackets 50 are shown, additional support brackets 50 may also be present to support the glass fence panel 20. Moreover, the support brackets 50 may perform a levelling feature as detailed hereinafter, in that it is desired that a series of glass fence panels 20 be aligned vertically, in spite of the fact that the floor or ground may not be perfectly flat.

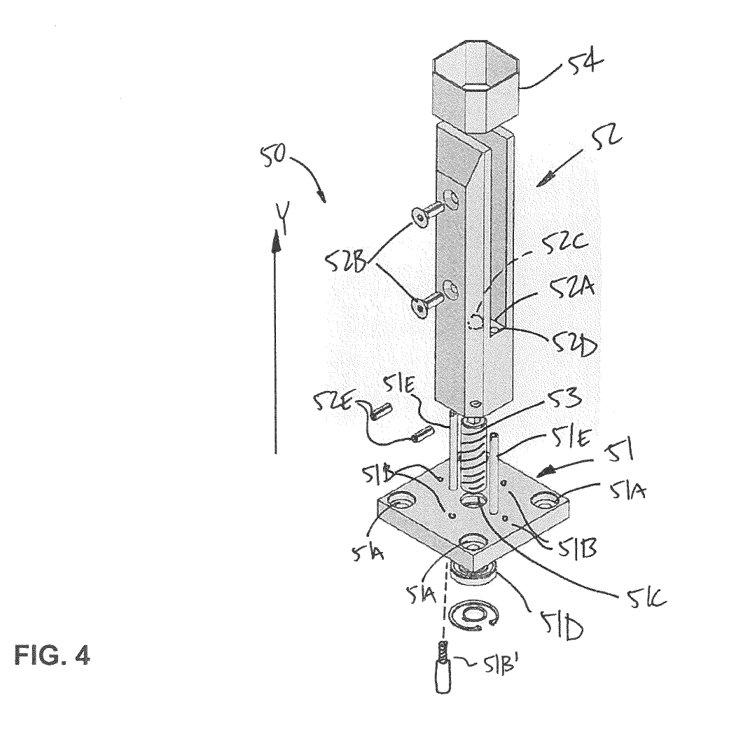

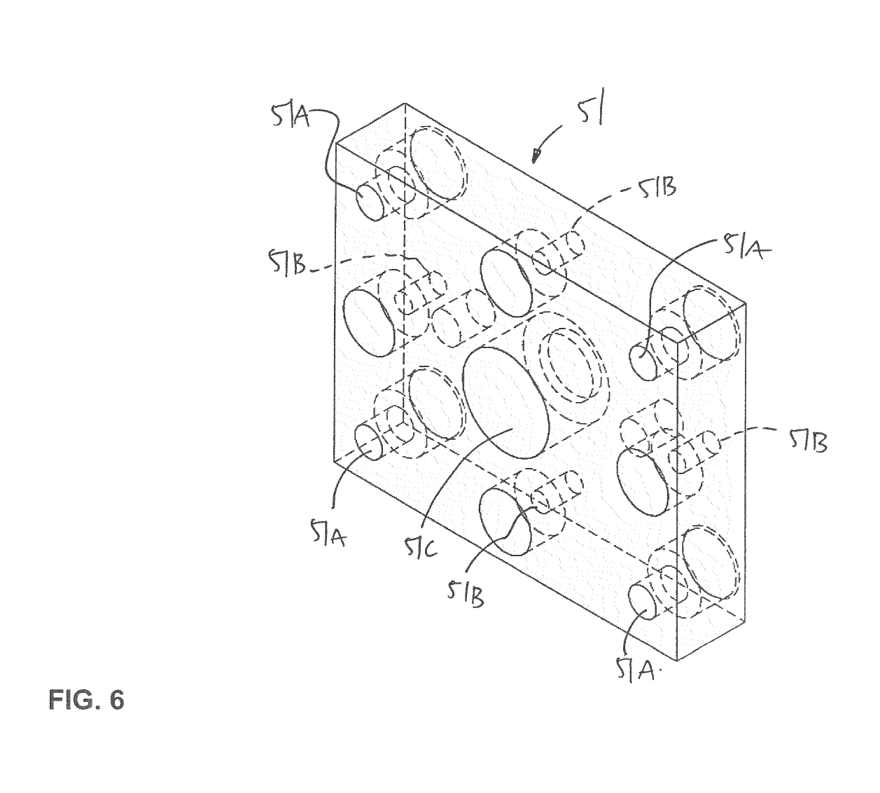

Referring to FIGS. 4, 5 and 6, each of the support brackets 50 has a base 51. The base 51 is shown as having a plate-like body, of square shape, although other shapes are considered as well. The base 51 has a set of anchoring bores 51A. The anchoring bores 51A may have a counterbore as illustrated, or a countersink, and are used to receive fasteners such as bolts that will anchor the base 51 to the ground, floor or like structure. The base 51 also has a leveling adjustment mechanism to enable the leveling of the base 51 relative to the ground, floor or structure. According to an embodiment, the leveling adjustment mechanism has threaded bores 51B that are used to level the base 51 relative to the ground, floor or like structure. The tapped bores 51B are in two sets, each set being on opposite sides of a central bore 51C of the base 51 (other arrangements are contemplated, such as a tripod configuration). Each of the tapped bores 51B is configured to receive legs 51B′ (only one of which is shown in FIG. 4 for simplicity). The legs 51B′ are in the form of set screws therefore received in the threaded bores 51B. The socket head of the legs 51B′ may be accessible from a top surface of the base 51, to enable slight leveling adjustments from the top. The legs 51B′ project from an undersurface of the base 51. For instance, at least two legs 51B′ are required to enable a desired levelling (e.g., two legs 51B′ moving upward and downward along axis Y, for one fixed leg 51B′, in a tripod configuration; or three or four legs 51B′ moving upward and downward). The ends of the set screws may have end plugs for greater footprint (as shown in FIG. 4), whereby the base 51 may have a downwardly facing counterbore as per FIG. 6. An installer may therefore use a level and tool (e.g., Allen key) to adjust the projection of the set screws relative to the base 51 and ensure that the base 51 is substantially horizontal. The above is one among other leveling adjustment mechanisms that may be used to adjust a level of the base 51 relative to the ground.

The bracket 50 may also have a height adjustment mechanism, to adjust a height of a glass interface 52 relative to the base 51. The height adjustment mechanism may comprise a bearing 51D seated in a receptacle defined by the central bore 51. The height adjustment mechanism may also have upwardly projecting guides 51E, used to adjust a height of glass interface 52 relative to the base 51, as described hereinafter. The central bore 51C may use a retaining clip to hold the bearing 51D captive therein, as is conventionally known.

The glass interface 52 may be a U-shaped post 52 projecting upwardly from the base 51 and having a slot 52A therein. The slot 52A is sized so as to snuggly receive therein the glass fence panel 20. Hence, when the glass fence panel 20 is received in the slots 52A of a pair of the brackets 50, the glass fence panel 20 is in its upstanding position shown in FIG. 1. Fasteners 52B project transversely into the slot 52A. The fasteners 52B may pass through throughbores in the glass fence panel 20 (not shown) or press against the glass fence panel 20, to anchor the glass fence panel 20 to the support brackets 50. The fasteners 52B are one of numerous solutions considered to secure the glass fence panel 20 to the support brackets 50, others including an adhesive, pressure pads, etc.

In a bottom of the slot 52A, a threaded bore 52C extends all the way to a bottom of the glass interface 52, as do channels 52D. Threaded rod 53 is therefore engaged into the tapped bore 52C and, by rotating the threaded rod 53 via the socket 53A accessible from the slot 52A, the vertical position of the glass interface 52 relative to the base 51 is adjusted. The threaded rod 53 has a bottom end connected to the bearing 51D, and is held captive for instance using a retaining clip, so as to be fixed in vertical translation (i.e., along axis Y). Hence, a rotation of the threaded rod 53 will result in upward or downward movement of the glass interface 52 relative to the base 51, as part of the height adjustment mechanism. The upwardly projecting guides 51E secured to the base 51 penetrate the channels 52D in the post 52, whereby the post 52 is limited to a translational up and down movement relative to the base 51. It is pointed out that the guides (i.e., pins) could be part of the glass interface 52 and the corresponding channels (i.e., holes) could be in the base 51.

In assembly, the base 51, loosely attached to the ground with fasteners in the anchoring bores 51A, is leveled as mentioned above, using the leveling adjustment mechanism of sets screws 51B′ in the threaded bores 51B, i.e., the leveling adjustment mechanism is lockable in height by the set screws 51B′ being fixed in translation unless rotated. When the base 51 is leveled, the fasteners in the anchoring bores 51A may immovably anchor the base 51 to the ground. The glass interface 52 may then be screwingly engaged on the threaded rod 53, with the guides 51E penetrating the channels 52D. The height adjustment of the post 52 may be performed by inserting an Allen key or similar elongated tool via the tapped bore 52C in the bottom of the slot 52A of the post 52, to reach the threaded rod 53, until a desired height is reached. For example, the desired height may be reached by levelling the post 52 with the post 52 of an adjacent support bracket 50. Once a desired height is reached, set screws 52E may apply pressure on the guides 51E to lock the post 52 in height. This height adjustment mechanism therefore converts a rotational input into a translational vertical movement of the post 52 relative to the base 51, and other similar arrangements are considered as well. It is also contemplated to provide the post 52 with a translational joint, but without the endless screw mechanism described above, although the endless screw mechanism has the capability of remain fixed in translation if not rotated, i.e., it is lockable at a desired height. In such a case, the post 52 would simply be moved up and down manually, and then locked by the set screws 52E. It would be necessary to provide suitable set screws to support the weight of the glass fence panel 20, for instance by using larger diameters, considering that in the illustrated embodiment the endless screw mechanism performs some of the load bearing.

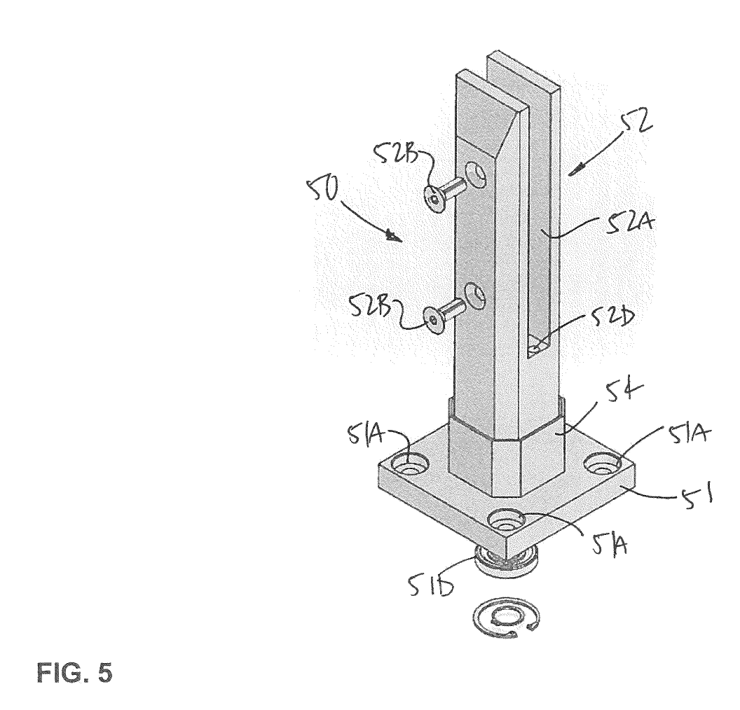

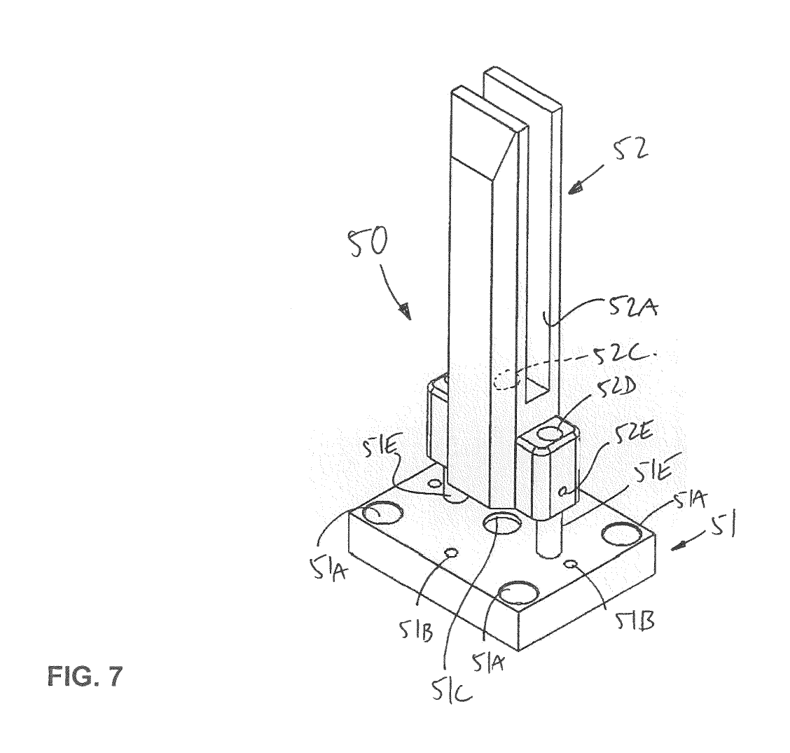

Covers or fairings 54 may then be slid onto the assembly to cover the fasteners and prevent tampering, as partially shown in FIG. 5, with another fairing used to cover the base 51. The glass fence panels 20 may then be received in the slots 52A of adjacent support brackets 50, and locked in place for instance using the fasteners 52B. FIG. 7 shows a sturdier built of the support bracket 50, yet with the same components.

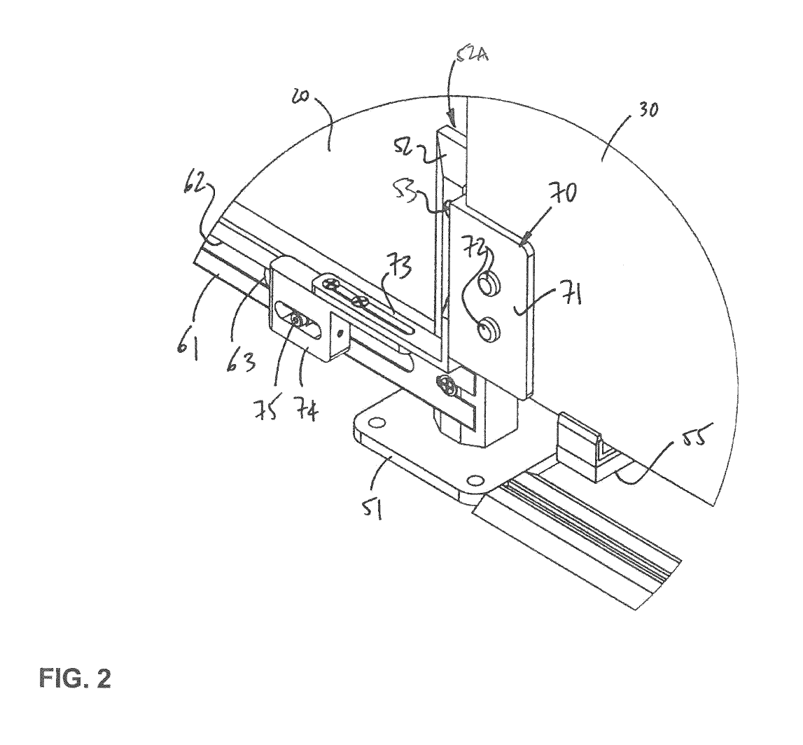

As shown concurrently in FIGS. 1 and 2, one of the support brackets 50 has a U-shaped guide 55. The support bracket 50 having the U-shaped guide 55 is that adjacent to the glass sliding gate 30. The U-shaped guide 55 projects from an arm 56, which arm 56 is connected to the post 52 of the support bracket 50, as best shown in FIG. 1. The U-shaped guide 55 may have a wear bearing component with low coefficient of friction, such as PTFE or the like, to contact the sliding gate 30 and limit friction between the glass sliding gate 30 and the U-shaped guide 55 when the glass sliding gate 30 moves in direction A. The U-shaped guide 55 limits out of plane vibrations or movements.

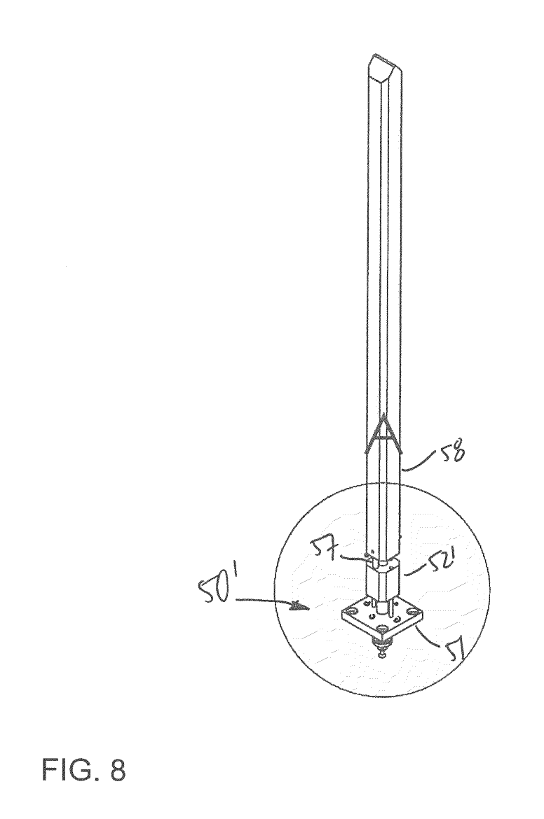

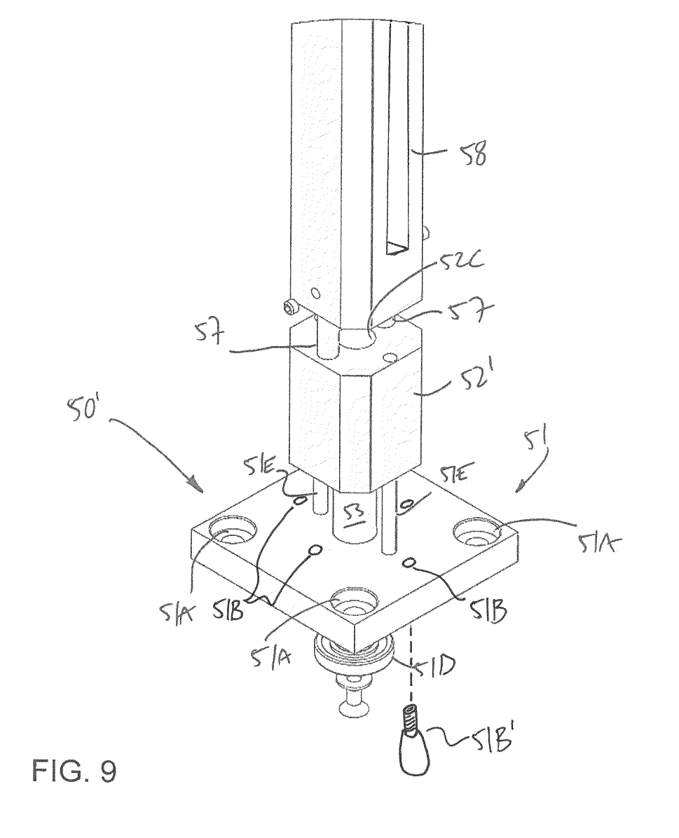

Referring to FIGS. 8 and 9, another embodiment of the support bracket is shown as 50′. The support bracket 50′ has numerous components in common with the support bracket 50, whereby like reference numerals will refer to like components. The support bracket 50′ has its glass interface 52 made of a bottom post portion 52′ that is adjustable in height relative to the base 51. However, unlike the glass interface 52 (FIGS. 4-7), the bottom post portion 52′ does not have a slot, but rather has a generally flat surface, with a pair of pins 57 projecting upwardly. The pins 57 are configured to couple the post 52′ to an elongated post portion 58 that will be the interface of the support bracket 50′ with a glass panel—although the pins 57 could be part of the post 58 instead, with bores in the post 52′. Hence, although not visible, the elongated post 58 has a slot therein for receiving an edge of a glass panel.

In installation, the height of the post 52′ is adjusted after the base 51 has been levelled. At that point, the elongated post 58 may be slid onto the pins 57, and set screws lock the assembly in place. The glass panel may then be inserted in the slot 58A of the elongated post 58. In an embodiment, the section and circumference of the posts 52′ and 58 are the same to provide a uniform look to the assembly.

Referring concurrently to FIGS. 1 and 2, the biasing mechanism 60 of the door closer is shown as having an elongated tube 61. The elongated tube 61 has any appropriate shape, but is shown having a square-section in FIGS. 1 and 2. The elongated tube 61 is held generally horizontal by being anchored at opposed ends to the support brackets 50. The elongated tube 61 has a longitudinal slot 62, the slot 62 opening to an interior of the elongated tube 61. A spring 63 is located inside the elongated tube 61. The spring 63 provides the biasing force to the biasing mechanism 60. The spring 63 may be any appropriate type of spring, such as an helical spring, a resilient deformable member, a leaf spring, etc. It is considered to provide a series of springs instead of a single spring, the series of springs being connected end to end. By having a plurality of springs, some more resilient than others, the biasing force may be more constant throughout movement of the sliding gate 30. This may also preclude too fast a closing speed influenced by the inertial of the sliding gate 30.

The door closer also features the door interface 70. The door interface 70 is operatively connected to both the biasing mechanism 60 and the sliding gate 30 to urge the sliding gate 30 to the closed position of FIG. 1. Accordingly, the door interface 70, as shown in FIGS. 1 and 2, has a bracket 71 by which it is secured to the glass sliding gate 30. In the illustrated embodiment, the door interface 70 is connected to a bottom corner of the sliding gate 30, although other locations are contemplated as well. Fasteners 72 may be provided to secure the bracket 71 to the glass sliding gate 30. The fasteners 72 are of any appropriate kind. It is also considered to use other types of connection to secure the bracket 71 to the glass sliding gate 30, one of the solutions including an adhesive, another being a pressure pad pressed against the sliding gate 30. An arm 73 projects from the bracket 71 away from the glass sliding gate 30. A carriage 74 is at a free end of the arm 73 and has a fastener or like projecting member 75 by which the carriage 74 contacts a free end of the springs 63. Therefore, the carriage 74 receives the biasing force of the spring 63 by way of the fastener 75 and thus transmits the force to the glass sliding gate 30. Although the door interface 70 is shown as having an arm 73, other configurations are considered. The arrangement of the arm 73 and carriage 74 with slots and fasteners as shown in FIG. 2 may allow an adjustment of the vertical position of the carriage 74 relative to the arm 73, to ensure an adequate amount of biasing force is transmitted to the sliding gate 30. Indeed, due to the mass of the sliding gate 30 and inherent momentum when moved, the biasing force should not be excessive in the event of collisions with users passing through the gate. It is preferred that the sliding gate 30 decelerate substantially prior to reaching the closed position of FIG. 1. Moreover, the sliding gate 30 must be manually pushed away from the closed position, whereby excessive biasing force could prevent the easy maneuvering of the gate 30. However, the biasing force should be sufficient to ensure that the gate 30 closes, and to prevent children from opening the gate 30.

Although not shown, an additional locking component may be used with a latch system to automatically lock the glass sliding gate 30 in the closed position shown in FIG. 1. Stated differently, upon having the glass sliding gate 30 reach the closed position in FIG. 1, the latch system may automatically lock the glass sliding gate 30 and prevent movement away from the closed position unless a detent or trigger is manually released. This may be used as an additional child safety feature.

The follower device 80 is connected to a bottom edge of the glass sliding gate 30, adjacent to a front edge thereof. The follower device 80 has a housing 81 with fasteners 82, by which the housing 81 may be secured to the glass sliding gate 30. A plunger 83 projects downwardly from the housing 81, and may be biased in a downward direction. The plunger 83 penetrates the rail 90 and the biasing of the plunger 83, in addition to gravity, ensures that the plunger 83 remains in the rail 90. Other configurations are considered for the follower device 80, such as a roller or caster. Moreover, the rail 90 may not be necessary as the roller may be directly against the ground.

1. A support bracket for supporting a glass panel comprising:
a base adapted to be anchored to a ground or structure;
a glass interface configured to be connected to a glass panel for the support bracket to support a portion of the glass panel;
a height adjustment mechanism operatively connecting the base to the glass interface, the height adjustment mechanism enabling a translational upward and downward movement of the glass interface relative to the base and being lockable to maintain the glass interface at a desired height; and
a leveling adjustment mechanism in the base for adjusting a level of the base relative to the ground or structure, the leveling adjustment mechanism being lockable to maintain the base at a desired leveling.

2. The support bracket according to claim 1, wherein the glass interface comprises a post having a slot therein for receiving a portion of a glass panel therein.

3. The support bracket according to claim 2, wherein the post has a bottom post portion operatively connected to the base, and an elongated post portion releasably secured on top of the bottom post portion, said slot being in the elongated post portion.

4. The support bracket according to claim 3, wherein the bottom post portion and the elongated portion are interconnected by at least one set of pins and holes.

5. The support bracket according to claim 2, wherein the post has a U-shaped body with the slot, to receive a bottom edge portion of the glass panel.

6. The support bracket according to claim 1, wherein the height adjustment mechanism comprises a threaded bore and threaded rod assembly.

7. The support bracket according to claim 6, wherein the threaded rod is rotatably connected to the base by a bearing.

8. The support bracket according to claim 7, wherein a tooling end of the screw is accessible via an opening in an upwardly facing surface of the glass interface, the nut being connected in line with a throughbore in the glass interface.

9. The support bracket according to claim 1, further comprising sets of pins and holes between the base and the glass interface to guide the upward and downward movement.

10. The support bracket according to claim 1, wherein the height adjustment mechanism further comprises set screws transversely oriented relative to the pins, the set screws being displaceable to press onto the pins to lock the glass interface at the desired height.

11. The support bracket according to claim 1, wherein the leveling adjustment mechanism comprises at least two legs displaceable upward and downward to level the base.

12. The support bracket according to claim 11, wherein the legs are threaded legs in threaded bores of the base.

13. The support bracket according to claim 12, wherein the threaded bores have a downwardly oriented counterbore, and enlarged ends are provided at a bottom of the threaded legs.

14. A glass sliding gate assembly comprising:
a glass gate comprising a main glass panel and a horizontal slot in the panel;
roller units adapted to be secured to a structure, the roller units each having a rolling wheel received in the horizontal slot to support the glass gate and rotate as the glass gate translates along its plane;
a door closer comprising:
a biasing mechanism adapted to be secured to the structure, and
a door interface secured to the glass gate, the door interface having a carriage operatively connected to the biasing mechanism so as to be subjected to a biasing force to bias the glass gate in a direction.

15. The glass sliding gate assembly according to claim 14, wherein the biasing mechanism comprises an elongated tube having biasing element in the elongated tube, and an elongated lateral slot, the carriage operatively connected to the biasing element through the elongated lateral slot.

16. The glass sliding gate assembly according to claim 14, further comprising at least one glass panel being the structure.

17. The glass sliding gate assembly according to claim 15, wherein two of the glass panels are spaced apart to form an opening therebetween, the glass gate being displaceable to open and close the opening.

18. The glass sliding gate assembly according to claim 14, further comprising a follower device connected to a bottom portion of the glass gate, the follower device interfacing the glass gate with the ground.

19. The glass sliding gate assembly according to claim 18, further comprising a rail on the ground, the follower device having an end received in the rail.

20. The glass sliding gate assembly according to claim 18, wherein the follower device has a suspension mechanism therein enabling vertical suspension.
